(19) United States
(12) Patent Application Publication
(10) Pub. No.: US 2011/0207403 A1
(43) Pub. Date: Aug. 25, 2011

(54) SYSTEM AND METHOD FOR CONTROLLING LONG-DISTANCE END-POINT TERMINAL IN CPNS ENVIRONMENT, AND CPNS SERVER AND MOBILE COMMUNICATION TERMINAL FOR THE SAME

(75) Inventors: In Hwan Kim, Seoul (KR); Jeong Hoon Lee, Seoul (KR); Jeong Min You, Seoul (KR)

(73) Assignee: SK Telecom Co., Ltd., Seoul (KR)

(21) Appl. No.: 13/127,916

(22) PCT Filed: Jun. 16, 2009
(86) PCT No.: PCT/KR09/03206

§ 371 Date: May 5, 2011

(30) Foreign Application Priority Data
Nov. 6, 2008 (KR) 10-2008-0109766

(51) Int. Cl. H04B 5/00

(52) U.S. Cl. 455/41.1

(57) ABSTRACT

The present invention relates to a system and a method for long-distance control of an end-point terminal in a CPNS environment, and a CPNS server and a mobile communication terminal for the same. When receiving a request for information from the end-point terminal the CPNS server[:] performs an authentication procedure for receiving the information from the end-point terminal to the mobile communication terminal and requests and receives the information from the end-point terminal for providing the mobile communication terminal with the information. The mobile communication terminal: requests and receives the information from the end-point terminal through the CPNS server, and controls the operation of the corresponding end-point terminal by transceiving the information with the end-point terminal through the CPNS server.

### TECHNICAL FIELD

The present invention relates to a system and method for controlling an end-point terminal placed at a long distance in a Converged Personal Network Service (CPNS) environment and a CPNS server and a mobile communication terminal for the same, and a mobile communication terminal and, more particularly, to a system and method for controlling an end-point terminal placed at a long distance in a CPNS environment and a CPNS server and a mobile communication terminal for the same, wherein a mobile communication terminal can control and manage an end-point terminal placed at a long distance and configured to perform near field radio communication with the other mobile communication terminal.

### BACKGROUND ART

With the development of information communication technology, a variety of end-point terminals, such as MPeg audio layer-3 (MP3) players, Personal Multimedia Players (PMPs), and Ultra Mobile Personal Computers (UMPCs) capable of playing document, images, and moving images, are being used.

A user downloads desired content to the end-point terminal from a Personal Computer (PC) and uses the downloaded content. There is a problem in that a user cannot download desired content in a situation where the user moves or cannot access a PC.

In order to solve the problem, there was proposed technology in which communication means connectable to a near-field communication network, such as Bluetooth or Ultra WideBand (UWB), is added to the end-point terminal.

According to the technology, content can be downloaded from an external device over a near field radio communication network. This method may be used to download content stored in an external device. However, the method is problematic in that content desired by a user, but not stored in an external device cannot be downloaded.

Furthermore, although near field radio communication is used, a mobile communication terminal cannot be directly provided with content or service, previously provided by a service provider or a mobile communication company, using the existing cellular communication.

### DISCLOSURE

### Technical Problem

To solve the above problems, the present invention proposes CPNS technology in which an end-point terminal, such as a PMP, is connected to a mobile communication terminal through near field radio communication and desired service can be received in such as way as to access the existing content service provider using the cellular communication function of the mobile communication terminal.

Meanwhile, although it is necessary for a mobile communication terminal, placed at a long distance in a CPNS environment, to control an end-point terminal performing near field radio communication with the other mobile communication terminal, the end-point terminal cannot be controlled because relevant technologies are not provided.

The present invention has been made in view of the above problems occurring in the prior art, and an object of the present invention is to provide a system and method for controlling an end-point terminal placed at a long distance in a CPNS environment and a CPNS server and a mobile communication terminal for the same, wherein a mobile communication terminal placed at a long distance in a CPNS environment receives information about an end-point terminal, associated with the other mobile communication terminal and configured to perform near field radio communication, and can control and manage the end-point terminal.

Furthermore, another object of the present invention is to enable a user to control and manage his end-point terminal, placed at a long distance, through the other mobile communication terminal.

### TECHNICAL SOLUTION

To achieve the above objects, a system according to an aspect of the present invention comprises a CPNS server for, when a request for information about an end-point terminal, transmitting and receiving information to and from the other mobile communication terminal over a near field radio communication network, from a mobile communication terminal, performing a certification procedure of checking whether the mobile communication terminal can receive the information of the end-point terminal, searching for the other mobile communication terminal associated with the end-point terminal, requesting the information of the end-point terminal from the other mobile communication terminal, receiving the information of the end-point terminal from the other mobile communication terminal, and providing the received information to the mobile communication terminal; and the mobile communication terminal for requesting, from the CPNS server, the information of the end-point terminal placed in an area other than its own near field radio communication area, receiving the information of the end-point terminal from the CPNS server, and controlling an operation of the end-point terminal by transmitting and receiving information to and from the end-point terminal through the CPNS server.

It is preferred that the CPNS server previously store pieces of terminal information about the end-point terminal and the other mobile communication terminal.

It is preferred that the mobile communication terminal have transmitted and received information to and from the end-point terminal, associated with the other mobile communication terminal, more than once and store its own mobile ID and the ID of the end-point terminal and relevant information which are matched.

It is preferred that the end-point terminal have transmitted and received information to and from the mobile communication terminal more than once and stores and manages the mobile IDs of the mobile communication terminal and the other mobile communication terminal and relevant information which are matched.

According to another aspect of the present invention, there is provided a CPNS server for providing information about an end-point terminal, performing near field radio communication with the other mobile communication terminal, to a specific mobile communication terminal placed at a long distance. The server comprises a communication interface unit for performing communication over a mobile communication network; an end-point terminal information request reception unit for receiving, from the mobile communication terminal, a request for the information about the end-point terminal, associated with the other mobile communication terminal and configured to perform near field radio communication with the other mobile communication terminal; a certification processing unit for checking whether the mobile communication terminal is eligible to request the information of the end-point terminal; an end-point terminal search unit for, if the mobile communication terminal is certified by the certification processing unit, searching for the other mobile communication terminal associated with the end-point terminal based on the end-point terminal; an information request and providing unit for requesting the information of the end-point terminal from the other mobile communication terminal, receiving the requested information from the other mobile communication terminal, and providing the received information to the mobile communication terminal which has requested the information of the end-point terminal; and a database for storing information about the CPNS server, including terminal information about the end-point terminal and the other mobile communication terminal.

It is preferred that when control request information including content selection information for the end-point terminal is received from the mobile communication terminal, the information request and providing unit transmit reply information, corresponding to the request, to the mobile communication terminal.

It is preferred that the CPNS server further comprise a mobile communication terminal information management unit for registering information about the mobile communication terminal transmitting and receiving information to and from the end-point terminal over a near field radio communication network, including a mobile ID, with the database and for managing the registered information.

It is preferred that the CPNS server further comprise an end-point terminal information management unit for storing the information of the end-point terminal, including specification information about the end-point terminal transmitting and receiving information to and from the mobile communication terminal over the near field radio communication network, in the database and for managing the stored information.

According to yet another aspect of the present invention, there is provided a mobile communication terminal connected to a CPNS server and configured to control an end-point terminal associated with the other mobile communication terminal and placed at a long distance. The mobile communication terminal comprises a wireless communication unit for performing wireless communication over a near field radio communication network or a mobile communication network; an end-point terminal information request unit for requesting, from the CPNS server, information about the end-point terminal performing near field radio communication with the other mobile communication terminal; and an end-point terminal control unit for performing service control, including a content request, a service start and end for the end-point terminal, based on the information of the end-point terminal received from the CPNS server.

It is preferred that the mobile communication terminal further comprise a billing information providing unit for providing its own billing-related information to the CPNS server so that billing for the end-point terminal is charged to the mobile communication terminal.

It is preferred that the mobile communication terminal further comprise an end-point terminal information management unit for providing the information of the end-point terminal, received from the CPNS server, to an end-point terminal placed at a short distance and configured to directly perform near field radio communication with the mobile communication terminal so that the end-point terminal placed at a short distance can control the end-point terminal placed at a long distance.

According to still yet another aspect of the present invention, there is provided a method of controlling an end-point terminal placed at a long distance in a system including a CPNS server and a mobile communication terminal. The method comprises the steps of (a) receiving, from the mobile communication terminal, a request for information about the end-point terminal, transmitting and receiving information to and from the other mobile communication terminal over a near field radio communication network; (b) performing a certification procedure of checking whether the mobile communication terminal which has requested the information at the step (a) is eligible to be provided with the information of the end-point terminal; (c) if, as a result of the check at the step (b), the mobile communication terminal is eligible to be provided with the information of the end-point terminal, searching for the other mobile communication terminal associated with the end-point terminal, requesting the information of the end-point terminal from the other mobile communication terminal, and receiving the information of the end-point terminal from the other mobile communication terminal; (d) providing the mobile communication terminal with the information of the end-point terminal received at the step (c); and (e) the mobile communication terminal selecting content provided from the CPNS server to the end-point terminal and managing and controlling the end-point terminal as well as the start and end of service.

After the step (e), the method further comprises the step of the mobile communication terminal providing the information of the end-point terminal, received from the CPNS server, to an end-point terminal placed at a short distance and configured to directly perform near field radio communication with the mobile communication terminal so that the end-point terminal placed at a short distance can control the end-point terminal placed at a long distance.

After the step (e), the method further comprises the step of the mobile communication terminal transmitting its own billing-related information to the CPNS server so that billing for the service use of the end-point terminal is charged to the mobile communication terminal.

According to still yet another aspect of the present invention, there is provided a method of a CPNS server providing information about an end-point terminal placed at a long distance at the request of a mobile communication terminal. The method comprises the steps of (a) receiving, from the mobile communication terminal, a request for the information of the end-point terminal transmitting and receiving information to and from the other mobile communication terminal over a near field radio communication network; (b) performing a certification procedure of checking whether the mobile communication terminal which has requested the information at the step (a) is eligible to be provided with the information of the end-point terminal; (c) if, as a result of the check at the step (b), the mobile communication terminal is eligible to be provided with the information of the end-point terminal, searching for the other mobile communication terminal associated with the end-point terminal, requesting the information of the end-point terminal from the other mobile communication terminal, and receiving the information of the end-point terminal from the other mobile communication terminal; and (d) providing the mobile communication terminal with the information of the end-point terminal received at the step (c).

After the step (d), it is preferred that the method further comprise the step of, when control request information including content selection information for the end-point terminal is received from the mobile communication terminal, providing reply information, corresponding to the request, to the mobile communication terminal.

Prior to the step (a), it is preferred that the method further comprise the step of registering pieces information about the mobile communication terminal and the end-point terminal, including a mobile ID of the mobile communication terminal transmitting and receiving information to and from the end-point terminal over the near field radio communication network and an ID and specification of the end-point terminal.

According to still yet another aspect of the present invention, there is provided a method of a mobile communication terminal connected to a CPNS server and configured to control an end-point terminal, placed at a long distance and associated with the other mobile communication terminal, in a CPNS environment. The method comprises the steps of (a) requesting, from the CPNS server, information about the end-point terminal performing near field radio communication with the other mobile communication terminal; (b) performing service control, including a content request and the start and end of service for the end-point terminal, based on the information of the end-point terminal received from the CPNS server; and (c) providing its own billing-related information to the CPNS server so that billing for the end-point terminal is charged to the mobile communication terminal.

After the step (b), it is preferred that the method further comprises the step of providing the information of the end-point terminal, received from the CPNS server, to an end-point terminal placed at a short distance and configured to directly perform near field radio communication with the mobile communication terminal so that the end-point terminal placed at a short distance can control the end-point terminal placed at a long distance.

### ADVANTAGEOUS EFFECTS

As described above, the system and method for controlling an end-point terminal placed at a long distance in a CPNS environment and the CPNS server and the mobile communication terminal for the same according to the present invention may have an effect that an end-point terminal associated with the other mobile communication terminal can be controlled and managed even at a long distance.

Furthermore, the present invention may have an effect that a user can control and manage his end-point terminal, placed at a long distance, through the other mobile communication terminal.

In addition, there is an advantage in that a mobile communication company or a content service provider may expand the service range, limited to the existing mobile communication terminal, to a variety of application terminals, have content frequently used, and increase profits.

### DESCRIPTION OF DRAWINGS

FIG. 1 is a diagram showing a connection between a system and a communication network according to the present invention;

FIG. is a flowchart illustrating an initial setting method for CPNS according to the present invention;

FIG. 3 is a diagram showing the configuration of a CPNS server according to the present invention;

FIG. 4 is a diagram showing the configuration of a mobile communication terminal according to the present invention; and

FIG. 5 is a flowchart illustrating a method of controlling an end-point terminal placed at a long distance according to the present invention.

<Description of reference numerals of principal elements in the drawings>

100: CPNS server 110: communication interface unit

120: mobile communication terminal information management unit

130: end-point terminal information management unit

140: end-point terminal information request reception unit

150: certification processing unit

160: end-point terminal search unit

170: information request and providing unit

180: database 200: mobile communication terminal

210: wireless communication unit 220: input unit

230: output unit 240: storage unit

250: end-point terminal information request unit

260: end-point terminal control unit

270: billing information providing unit

280: end-point terminal information management unit

300: end-point terminal

### MODE FOR INVENTION

In a CPNS environment disclosed in the present invention, a portable terminal which can perform only near field radio communication, but cannot perform cellular communication over a mobile communication network is enabled to employ data service that can be provided through cellular communication by performing near field radio communication with a mobile communication terminal which plays the role of a PN (Personal Network) service gateway.

Hereinafter, preferred embodiments of the present invention are described in more detail with reference to the accompanying drawings.

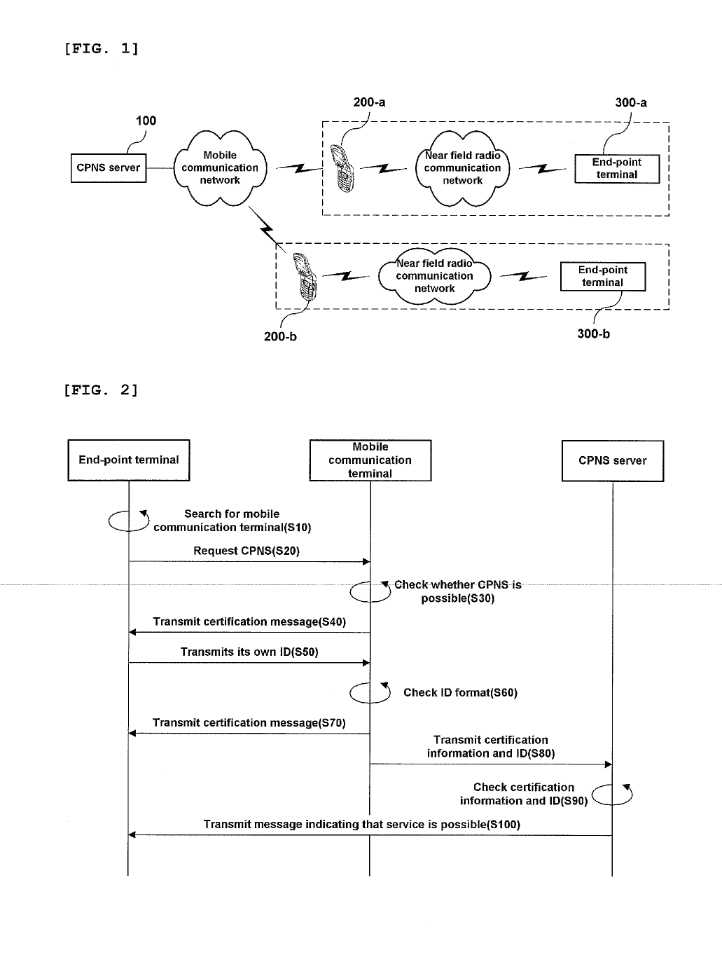

FIG. 1 is a diagram showing a connection between a system and a communication network according to the present invention.

The system according to the present invention includes a CPNS server 100 and a mobile communication terminal 200. When a request for information about an end-point terminal 300-b, transmitting and receiving information to and from the other mobile communication terminal 200-b over a near field radio communication network, is received from a mobile communication terminal 200-a, the CPNS server 100 performs a certification procedure about whether the mobile communication terminal 200-a can receive the information of the end-point terminal 300-b, checks the other mobile communication terminal 200-b associated with the end-point terminal 300-b, requests and receives the information of the end-point terminal 300-b, and provides the received information to the mobile communication terminal 200-a. The mobile communication terminal 200 requests information of the end-point terminal 300-b, placed in an area other than its own near field radio communication area, from the CPNS server 100, receives the information of the end-point terminal 300-b, and then controls the operation of the end-point terminal 300-b by transmitting and receiving the information to and from the corresponding end-point terminal 300-b through the CPNS server 100.

Here, the CPNS server 100 previously stores terminal information about the end-point terminal 300-b and the other mobile communication terminal 200-b.

Furthermore, the mobile communication terminal 200-a has previously transmitted and received information to and from the end-point terminal 300-b, associated with the other mobile communication terminal 200-b, more than once and stores and manages its own mobile ID and the ID of the end-point terminal and relevant information which are matched.

The end-point terminal 300-b has previously transmitted and received information to and from the mobile communication terminal 200-a more than once and stores and manages the mobile IDs of the mobile communication terminal 200-a and the other mobile communication terminal 200-b and relevant information which are matched.

Hereinafter, an end-point terminal referring to both reference numerals 300-a and 300-b is assigned reference numeral 300, and a mobile communication terminal referring to both reference numerals 200-a and 200-b is assigned reference numeral 200.

The end-point terminal 300 disclosed in FIG. 1 refers to a portable terminal equipped with a near field radio communication function, such as a personal multimedia player (PMP), an MP3 Player, a navigator, a mobile phone, and a game machine.

Meanwhile, the near field radio communication network includes all communication networks enabling near field radio communication, such as WLAN, Bluetooth, and UWB (Ultra WideBand).

On the other hand, the CPNS server 100, the mobile communication terminal 200, and the end-point terminal 300 shown in FIG. 1 experience an initial setting process for CPNS, which is described later.

FIG. 2 is a flowchart illustrating an initial setting method for CPNS according to the present invention.

First, the end-point terminal 300 searches for a mobile communication terminal to play the role of a PN (Personal Network) Gateway Device in order to use CPNS at step S10.

Next, the end-point terminal 300 requests service from the mobile communication terminal 200 retrieved at step S10. Here, the end-point terminal also transmits information, indicating that CPNS is possible, to the mobile communication terminal 200 at step S20.

When the service request is received from the end-point terminal, the mobile communication terminal 200 checks whether the end-point terminal can use the CPNS at step S30.

If, as a result of the check at step S30, the end-point terminal can use the CPNS, the mobile communication terminal 200 transmits a certification message, indicating that the CPNS is available, to the end-point terminal 300 at step S40.

When the certification message indicating that the CPNS is available is received from the mobile communication terminal, the end-point terminal 300 transmits its own ID to the mobile communication terminal 200 at step S50.

The mobile communication terminal 300 confirms whether the format of the ID, received from the end-point terminal 200, is identical with the format of an ID issued by the CPNS at step S60. If, as a result of the confirmation, the format of the ID, received from the end-point terminal 200, is identical with the format of the ID issued by the CPNS, the mobile communication terminal 300 transmits a certification message, indicating that the service is possible, to the end-point terminal 300 at step S70.

Next, the mobile communication terminal 200 transmits its own certification information and ID and the certification information and ID of the end-point terminal 300 to the CPNS server 100 at step S80.

The CPNS server 100 determines whether the CPNS is available to the mobile communication terminal and the end-point terminal by confirming the pieces of certification information and the IDs received from the mobile communication terminal at step S90.

If, as a result of the determination, the CPNS is determined to be available to both the mobile communication terminal and the end-point terminal, the CPNS server 100 informs the end-point terminal of this fact so that the end-point terminal can perform the CPNS, including a request for content, at step S100.

If, as a result of the determination at step S90, the CPNS is determined not to be available to any one of the mobile communication terminal and the end-point terminal, the CPNS server 100 informs the end-point terminal of this fact and terminates the process.

Meanwhile, if, as a result of the check at step S30, the CPNS is not available to the end-point terminal, the mobile communication terminal 200 transmits a message, indicating that the service is not available, to the end-point terminal 300 and then terminates the process.

On the other hand, if, as a result of the confirmation at step S60, the format of the ID, received from the end-point terminal 200, is not identical with the format of the ID issued by the CPNS, the mobile communication terminal 300 transmits a message, indicating that the service is not available, to the end-point terminal 300 and then terminates the process.

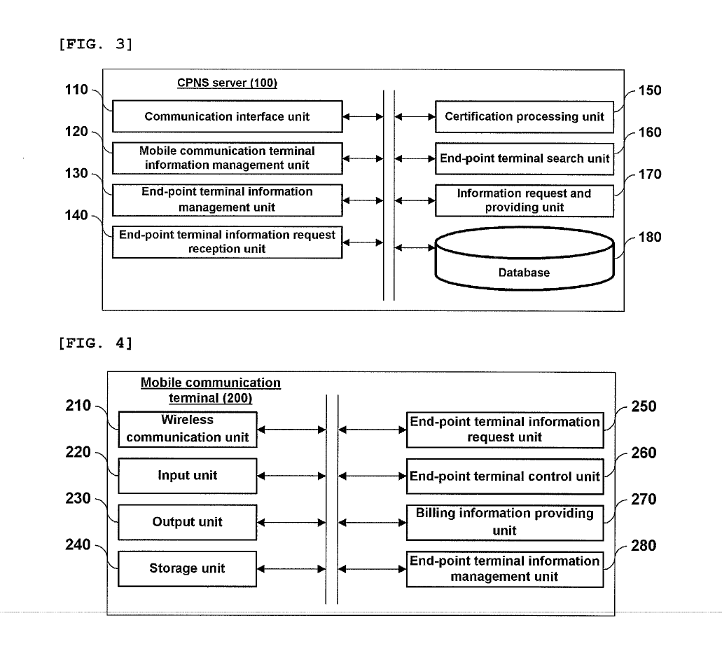

FIG. 3 is a diagram showing the configuration of the CPNS server according to the present invention.

As shown, the CPNS server 100 includes a communication interface unit 110, a mobile communication terminal information management unit 120, an end-point terminal information management unit 130, an end-point terminal information request reception unit 140, a certification processing unit 150, an end-point terminal search unit 160, an information request and providing unit 170, and a database 180.

More particularly, the communication interface unit 110 is an element for performing communication over a mobile communication network.

The mobile communication terminal information management unit 120 registers information about the mobile communication terminal 200 that transmits and receives information to and from the end-point terminal 300 over a near field radio communication network, including a mobile ID, with the database 180 and manages the registered information.

The end-point terminal information management unit 130 stores information about the end-point terminal 300 that transmits and receives information to and from the mobile communication terminal 200 over a near field radio communication network, including specification information about the end-point terminal 300, in the database 180 and manages the stored information.

The end-point terminal information request reception unit 14 receives a request for information about the end-point terminal 300-b, performing near field radio communication with the other mobile communication terminal 200-b, from the mobile communication terminal 200-a.

The certification processing unit 150 confirms whether the mobile communication terminal 200-a is eligible to request the information of the end-point terminal 300-b.

If the mobile communication terminal 200-a is certified by the certification processing unit 150, the end-point terminal search unit 160 searches for the other mobile communication terminal 200-b associated with the end-point terminal 300-b on the basis of the end-point terminal 300-b.

The information request and providing unit 170 requests information about the end-point terminal 300-b from the other mobile communication terminal 200-b, receives the requested information from the other mobile communication terminal 200-b, and provides the received information to the corresponding mobile communication terminal 200-a which has requested the information of the end-point terminal 300-b.

Furthermore, when control request information including content selection information about the end-point terminal 300-b is received from the mobile communication terminal 200-a, the information request and providing unit 170 transmits reply information, corresponding to the request, to the mobile communication terminal 200-a.

For example, when the mobile communication terminal 200-a requests content selection information about the end-point terminal 300-b and the start and end of service, the information request and providing unit 170 requests the corresponding content from the content providing server (not shown) and transfers the corresponding content to the mobile communication terminal 200-a or starts or ends CPNS.

The database 180 stores information relevant to the CPNS server, including terminal information about the end-point terminal 300 and the mobile communication terminal 200.

FIG. 4 is a diagram showing the configuration of the mobile communication terminal according to the present invention.

As shown, the mobile communication terminal 200 includes a wireless communication unit 210, an input unit 220, an output unit 230, a storage unit 240, an end-point terminal information request unit 250, an end-point terminal control unit 260, a billing information providing unit 270, and an end-point terminal information management unit 280.

The wireless communication unit 210 for performing wireless communication with the mobile communication terminal 200 over a near field radio communication network or a mobile communication network, the input unit 220 for input control, the output unit 230 for aurally or visually providing necessary data when voice call service or data service is used, and the storage unit 240 for storing various data are the common elements of a mobile communication terminal, and a detailed description thereof is omitted.

The end-point terminal information request unit 250 requests information about the end-point terminal 300-b, performing near field radio communication with the other mobile communication terminal 200-b, from the CPNS server 100.

The end-point terminal control unit 260 performs service control, including a content request for the end-point terminal 300-b and the start and end of service, on the basis of the information of the end-point terminal received from the CPNS server 100.

The billing information providing unit 270 provides its own billing-related information to the CPNS server 100 so that billing for the end-point terminal 200-b is charged to the mobile communication terminal.

The end-point terminal information management unit 280 provides the information of the end-point terminal 300-b, received from the CPNS server 100, to an end-point terminal 300-a directly performing near field radio communication with itself at a short distance so that the end-point terminal 300-a placed at a short distance can control the end-point terminal 300-b placed at a long distance.

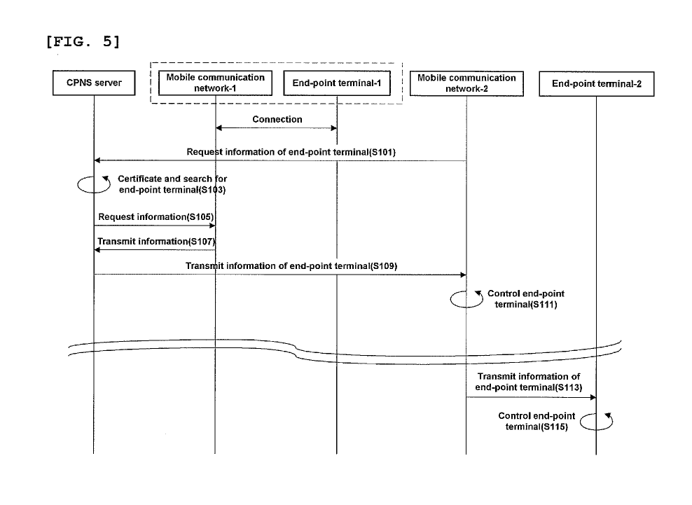

FIG. 5 is a flowchart illustrating a method of controlling the end-point terminal placed at a long distance according to the present invention.

Although not shown, the CPNS server 100 stores pieces of information about the mobile communication terminal 200 and the end-point terminal 300, including the mobile ID of the mobile communication terminal 200, transmitting and receiving information to and from the end-point terminal 300 over a near field radio communication network, the ID and specification of the end-point terminal 300.

The mobile communication terminal 200-a requests information about the end-point terminal 300-b, performing near field radio communication with the other mobile communication terminal 200-b, from the CPNS server 100 at step S101.

The CPNS server 100 receives the request for information about the end-point terminal 300-b (the end-point terminal-2 of FIG. 5), transmitting and receiving information to and from the other mobile communication terminal 200-b (the mobile communication terminal-1 of FIG. 5) from the mobile communication terminal 200-a (the mobile communication terminal-2 of FIG. 5) over a near field radio communication network at step S101.

The CPNS server 100 performs a certification procedure of checking whether the mobile communication terminal 200-a is eligible to receive the information of the end-point terminal 300-b, requested at step S101.

If, as a result of the check, the mobile communication terminal 200-a is eligible to receive the information of the end-point terminal 300-b, the CPNS server 100 searches for the other mobile communication terminal 200-b associated with the end-point terminal 300-b at step S103, requests the information of the end-point terminal 300-b from the other mobile communication terminal 200-b at step S105, and receives the information of the end-point terminal 300-b from the other mobile communication terminal 200-b at step S107.

The CPNS server 100 provides the information of the end-point terminal 300-b, received at step S107, to the mobile communication terminal 200-a at step S109.

Next, the mobile communication terminal 200-a performs service control, including a content request and a service start and end for the end-point terminal 300-b, on the basis of the information of the end-point terminal 300b received from the CPNS server 100 at step S111.

For example, the mobile communication terminal 200-a may select content provided to the end-point terminal 300-b or manage and control the end-point terminal 300-b, such as the start and end of the service.

Here, when the control request information including content selection information for the end-point terminal 300-b is received from the mobile communication terminal 200-a, the CPNS server 100 provides reply information, corresponding to the request, to the mobile communication terminal 200-a.

The mobile communication terminal 200-a may provide the information of the end-point terminal 300-b, received from the CPNS server 100, to the short-distance end-point terminal 300-a directly performing near field radio communication with the mobile communication terminal 200-a at step S113 so that the end-point terminal 300-a placed at a short distance controls the end-point terminal 300-b placed at a long distance at step S115.

Meanwhile, although not shown, the mobile communication terminal 200-a may transmit its own billing-related information to the CPNS server 100 so that billing for the service use of the end-point terminal is charged to the mobile communication terminal 200-a.

As described above, a person having ordinary skill in the art to which the present invention pertains will understand that the present invention may be implemented in various detailed forms without changing the technical spirit or indispensable characteristics of the present invention. It will be understood that the above-described embodiments are illustrative and not limitative from all aspects. The scope of the present invention is defined by the appended claims rather than the detailed description, and the present invention should be construed to cover all modifications or variations induced from the meaning and scope of the appended claims and their equivalents.

### INDUSTRIAL APPLICABILITY

The system and method for controlling an end-point terminal placed at a long distance in a CPNS environment and the CPNS server and the mobile communication terminal for the same are suitable to control and manage an end-point terminal associated with the other mobile communication terminal even at a long distance.

1. A system for controlling an end-point terminal placed at a long distance in a CPNS (Converged Personal Network Service) environment, the system comprising:
a CPNS server for, when a request for information about an end-point terminal, transmitting and receiving information to and from the other mobile communication terminal over a near field radio communication network, from a mobile communication terminal, performing a certification procedure of checking whether the mobile communication terminal can receive the information of the end-point terminal, searching for the other mobile communication terminal associated with the end-point terminal, requesting the information of the end-point terminal from the other mobile communication terminal, receiving the information of the end-point terminal from the other mobile communication terminal, and providing the received information to the mobile communication terminal; and
the mobile communication terminal for requesting, from the CPNS server, the information of the end-point terminal placed in an area other than its own near field radio communication area, receiving the information of the end-point terminal from the CPNS server, and controlling an operation of the end-point terminal by transmitting and receiving information to and from the end-point terminal through the CPNS server.

2. The system according to claim 1, wherein the CPNS server previously stores pieces of terminal information about the end-point terminal and the other mobile communication terminal.

3. The system according to claim 1, wherein the mobile communication terminal has transmitted and received information to and from the end-point terminal, associated with the other mobile communication terminal more than once and stores and manages its own mobile ID and an ID of the end-point terminal and relevant information which are matched.

4. The system according to claim 1, wherein the end-point terminal has transmitted and received information to and from the mobile communication terminal more than once and stores and manages mobile IDs of the mobile communication terminal and the other mobile communication terminal and relevant information which are matched.

5. A CPNS server for providing information about an end-point terminal, performing near field radio communication with the other mobile communication terminal, to a specific mobile communication terminal placed at a long distance, the server comprising:
a communication interface unit for performing communication over a mobile communication network;
an end-point terminal information request reception unit for receiving, from the mobile communication terminal, a request for the information of the end-point terminal, associated with the other mobile communication terminal and configured to perform near field radio communication with the other mobile communication terminal;
a certification processing unit for checking whether the mobile communication terminal is eligible to request the information of the end-point terminal;
an end-point terminal search unit for, if the mobile communication terminal is certified by the certification processing unit, searching for the other mobile communication terminal associated with the end-point terminal based on the end-point terminal;
an information request and providing unit for requesting the information of the end-point terminal from the other mobile communication terminal, receiving the requested information from the other mobile communication terminal, and providing the received information to the mobile communication terminal which has requested the information of the end-point terminal; and
database for storing information about the CPNS server, including terminal information about the end-point terminal and the other mobile communication terminal.

6. The CPNS server according to claim 5, wherein when control request information including content selection information for the end-point terminal is received from the mobile communication terminal, the information request and providing unit transmits reply information, corresponding to the request, to the mobile communication terminal.

7. The CPNS server according to claim 5, further comprising a mobile communication terminal information management unit for registering information about the mobile communication terminal transmitting and receiving information to and from the end-point terminal over a near field radio communication network, including a mobile ID, with the database and for managing the registered information.

8. The CPNS server according to claim 5, further comprising an end-point terminal information management unit for storing the information of the end-point terminal, including specification information of the end-point terminal transmitting and receiving information to and from the mobile communication terminal over the near field radio communication network, in the database and for managing the stored information.

9. A mobile communication terminal connected to a CPNS server and configured to control an end-point terminal, associated with the other mobile communication terminal, at a long distance, the mobile communication terminal comprising:
a wireless communication unit for performing wireless communication over a near field radio communication network or a mobile communication network;
an end-point terminal information request unit for requesting, from the CPNS server, information about the end-point terminal, performing near field radio communication with the other mobile communication terminal; and
an end-point terminal control unit for performing service control, including a content request, service start and end for the end-point terminal, based on the information of the end-point terminal received from the CPNS server.

10. The mobile communication terminal according to claim 9, further comprising a billing information providing unit for providing its own billing-related information to the CPNS server so that billing for the end-point terminal is charged to the mobile communication terminal.

11. The mobile communication terminal according to claim 9, further comprising an end-point terminal information management unit for providing the information of the end-point terminal, received from the CPNS server, to an end-point terminal placed at a short distance and configured to directly perform near field radio communication with the mobile communication terminal so that the end-point terminal placed at a short distance can control the end-point terminal placed at a long distance.

12. A method of a CPNS server providing information about an end-point terminal placed at a long distance at a request of a mobile communication terminal in order to control the end-point terminal in a CPNS environment, the method comprising the steps of:
(a) receiving, from the mobile communication terminal, a request for the information of the end-point terminal transmitting and receiving information to and from the other mobile communication terminal over a near field radio communication network;
(b) performing a certification procedure of checking whether the mobile communication terminal which has requested the information at the step (a) is eligible to be provided with the information of the end-point terminal;
(c) if, as a result of the check at the step (b), the mobile communication terminal is eligible to be provided with the information of the end-point terminal, searching for the other mobile communication terminal associated with the end-point terminal, requesting the information of the end-point terminal from the other mobile communication terminal, and receiving the information of the end-point terminal from the other mobile communication terminal; and
(d) providing the mobile communication terminal with the information of the end-point terminal received at the step (c).

13. The method according to claim 12, further comprising the step of, when control request information including content selection information for the end-point terminal is received from the mobile communication terminal, providing reply information corresponding to the request, after the step (d).

14. The method according to claim 12, further comprising, before the step (a), the step of registering pieces of information about the mobile communication terminal and the end-point terminal, including a mobile ID of the mobile communication terminal transmitting and receiving information to and from the end-point terminal over the near field radio communication network and an ID and specification of the end-point terminal.

15. A method of a mobile communication terminal connected to a CPNS server and configured to control an end-point terminal, placed at a long distance associated with the other mobile communication terminal, in a CPNS environment, the method comprising the steps of:
(a) requesting, from the CPNS server, information about the end-point terminal performing near field radio communication with the other mobile communication terminal;
(b) performing service control, including a content request and a start and end of service for the end-point terminal, based on the information of the end-point terminal received from the CPNS server; and
(c) providing its own billing-related information to the CPNS server so that billing for the end-point terminal is charged to the mobile communication terminal.

16. The method according to claim 15, further comprising, after the step (b), the step of providing the information of the end-point terminal, received from the CPNS server, to an end-point terminal placed at a short distance and configured to directly perform near field radio communication with the mobile communication terminal so that the end-point terminal placed at a short distance can control the end-point terminal placed at a long distance.
